(19) United States
(12) Patent Application Publication
(10) Pub. No.: US 2010/0161145 A1
(43) Pub. Date: Jun. 24, 2010

(54) SEARCH ENGINE DESIGN AND COMPUTATIONAL COST ANALYSIS

(75) Inventors: Ricardo BAEZA-YATES, Barcelona (ES); Aristides GIONIS, Barcelona (ES); Flavio JUNQUEIRA, Barcelona (ES); Vassilis PLACHOURAS, Barcelona (ES); Luca TELLOLI, Barcelona (ES)

Correspondence Address: Weaver Austin Villeneuve & Sampson - Yahoo!, P.O. BOX 70250, OAKLAND, CA, 94612-0250, US

(73) Assignee: YAHOO! INC, Sunnyvale, CA (US)

(21) Appl. No.: 12/338,117

(22) Filed: Dec. 18, 2008

(51) Int. Cl. G06F 1/26; G06Q 10/00; G06Q 50/00; G06F 9/46

(52) U.S. Cl. 700/291; 705/7; 718/104; 705/412; 707/E17.108; 707/E17.032

(57) ABSTRACT

A computer implemented system for search engine facility architecting and design. The system estimates the costs of power and networking based on system parameters, such as average CPU utilization, connection time, and bytes transferred over the network. Regional distribution of facilities may be evaluated to take into account the various parameters and optimize the cost and speed of the systems being designed. The parameters used in analyzing and formulating an architecture are independent of a particular indexing or query processing technique.

### BACKGROUND OF THE INVENTION

This invention relates generally to search engines and queries.

Search engines use a large number of servers to perform tasks going from crawling, through indexing, and query processing. Centralized solutions are beneficial when the capacity of the system is not required to grow or grows slowly. However, centralized solutions provide limited scalability: the system can only grow to the extent allowed by the initial design of the data center hosting the system.

A better understanding of the costs associated with centralized and distributed architectures is necessary to efficiently plan and operate search facilities.

### SUMMARY OF THE INVENTION

Embodiments of the invention estimate the costs of power and networking based on system parameters, such as average CPU utilization, connection time, and bytes transferred over the network. Regional distribution of facilities may be evaluated to take into account the various parameters and optimize the cost and speed of the systems being designed. The parameters used in analyzing and formulating a search system architecture are independent of a particular indexing or query processing technique.

One embodiment relates to a computer system configured to: receive a target query volume; calculate the cost of operation for a proposed distributed search system comprising at least one search repository site geographically distant from a second search repository site; calculate the cost of networking the search repository sites of the distributed search system; calculate the cost of operation for a proposed centralized search system; and determine whether the cost of operation of the proposed distributed system is greater or less than the cost of operation of the proposed centralized system. Similarly, the system can also calculate and compare the costs of different distributed systems and determine the relative costs of the different distributed systems

Another embodiment relates to a computer program product, comprising a computer usable medium having a computer readable program code embodied therein. The computer readable program code is adapted to be executed to implement a method for designing a search engine system. The method comprises: determining a sum of power costs for at least two designs; determining a sum of bandwidth costs for the at least two designs, and determining an optimal number of nodes for the search engine system. The method may be used to compare the cost of different distributed architectures with a different number of nodes from the other, or the cost of designs with the same number of nodes, but with different networking topologies.

Another embodiment relates to a computer program product, comprising a computer usable medium having a computer readable program code embodied therein. The computer readable program code is adapted to be executed to implement a method for designing a search engine system. The method comprises: establishing a target latency for queries of a search processing system that services queries from a first geographic area and a second geographic area distant from the first geographic area; receiving a proposed topology for the search processing system; receiving a proposed location for a first site to service queries of the first and second geographic areas; receiving a proposed location for a second site to service queries of the first and second geographic areas, the first site being geographically distant from the second site; determining a power cost for power consumption of the first site by estimating power consumption of crawling operations of the first site; determining a power cost for power consumption of the first site by estimating power consumption of query processing operations of the first site; determining a power cost for power consumption of the second site by estimating power consumption of crawling operations of the second site; determining a power cost for power consumption of the second site by estimating power consumption of query processing operations of the second site; and calculating an overall operating cost of the search processing system from the power costs given the target latency, geographic areas to be served, proposed topology and locations.

A further understanding of the nature and advantages of the present invention may be realized by reference to the remaining portions of the specification and the drawings.

### BRIEF DESCRIPTION OF THE DRAWINGS

FIG. 1 is a flow chart of a method according to an embodiment of the invention.

FIGS. 2 and 3 are graphs illustrating examples of the cost of processing with a distributed architecture.

FIG. 4 is a simplified diagram of a computing environment in which embodiments of the invention may be implemented.

A further understanding of the nature and advantages of the present invention may be realized by reference to the remaining portions of the specification and the drawings.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Distributed architectures for search engines address issues with the scalability problem of centralized Web retrieval. As the data centers that host servers for a search engine have limited capacity, it is beneficial to have a system design that can cope with the growth of the Web, and that is not constrained by the physical limitations of a data center.

A typical solution to this design problem is to use a single, centralized site, since it is a simple and competitive solution, and to locate such a system in the place that provides the lowest cost of operation and the maximum benefit. Such a preference for a centralized solution often comes from a lack of understating of the benefits and drawbacks of a distributed solution. In fact, it is intuitively unclear whether the benefits of a distributed architecture compensate for the extra communication costs between the physical locations. An example of an important benefit of a distributed solution is the proximity between the engine machinery to data and users. Being closer to data implies that the system requires fewer machines to perform the same crawling, as the Web connections are shorter and the data transfer are faster. For the same reason fewer front end servers are necessary to handle the same query volume due to the faster service time. Embodiments of the present invention create a physical model and detailed cost analysis, allowing potential architectures to be analyzed and the cost-benefit ratio to be determined.

In general, as the overall workload is distributed, the cost of handling network bandwidth saturation, redundancy, and fault tolerance may also decrease. A distributed architecture also enables the service to exploit the potential local properties of the workload. First, locality implies lower utilization of the network, and thus, reduces the communication cost. Second, locality of queries may imply better local customization, since teams of developers can use local expertise to tailor services to local preferences, thus improving the user experience and increasing the advertising revenue.

Distributed solutions designed and evaluated with embodiments of the present invention are able to process a significant fraction of the queries locally. In practice, achieving the goal of processing all queries locally is difficult. More than one site might need to be used to process some of the submitted queries, hereinafter called non-local queries. The additional communication cost increases the total latency of query processing, and hence the latency for non-local queries is higher. On the other hand, local queries are processed faster. Local queries are those queries that can be processed by the site to which they are submitted. Locality refers to the fraction of the volume of queries that are local. Thus, if a relatively high percentage of queries are processed locally, then the average latency will be reduced.

In addition to locality, another factor is the volume of queries for which the distributed system retrieves more or fewer clicked documents than a centralized system, assuming that a click by a user on a retrieved document is an indication of relevance.

An example of a practical distributed architecture is a star topology. Such a topology has a minimal number of connections and requires only two hops between any pair of sites. The main drawback of this architecture is having to provision the center site in such a way that it can handle more traffic compared to other sites. That is, building and maintaining the center site is more costly. A central, more provisioned site, however, turns out to have advantageous aspects including that the central site may handle a significant fraction of the queries that are not processed locally. Moreover, this site may be located in the region with the highest query traffic and therefore benefit from a larger, well-provisioned site. The organization of the sites does not need to be flat, and sites can have special roles. For instance, embodiments of the system can organize them hierarchically with the sites having distinct roles. The optimal network topology to use is also part of the design process/parameters in analyzing distributed system architecture. For a collection of documents D over a set of terms T, the documents D are partitioned into two subsets: local (L) and global (G). Global documents are present in all sites, whereas local documents are further partitioned disjointly among the sites of S.

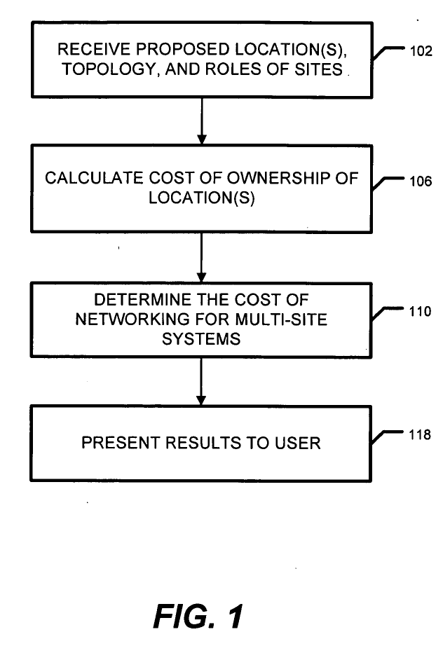

FIG. 1 is a flow chart, depicting, at a high level, a method of designing and evaluating search engine systems. In step 102, the system receives proposed location(s), topology, and roles of the sites. Then in step 106, the system calculates the cost of ownership of each of the location(s). In a preferred embodiment, the cost of ownership is primarily based upon the power consumption, although other factors may be taken into account, as discussed below. In determining the power consumption, many factors may be taken into account. For example, the number of operations per second that are needed, the number of servers needed for crawling, the number of servers needed for query processing, the CPU utilization, and target latency.

The cost of a data center is the sum of its initial cost and the cost of operating it over some period of time. The initial cost varies significantly, depending on factors such as the design choices (raised floor, server density, etc.), location and the value of local labor. This cost is usually amortized over the lifetime of the data center. Operational costs also vary significantly, and depend on factors such as power consumption, amount of network bandwidth, and maintenance costs. The described embodiments focus upon on the operational costs, and more specifically upon power consumption and network utilization. Power consumption and related expenses typically represent more than 60% of the cost in the lifetime of a data center. For more information, please refer to a paper from American Power Conversion entitled “Determining total cost of ownership for data center and network room infrastructure: White Paper #6,” available at, http://www.apcmedia.com/salestools/CMRP-5T9PQG_R3_EN.pdf, 2005.

The cost of a multi-site system is the sum of the individual costs of each site over some period of time. To build a site there is an initial cost (Init), which consists of setting up all the infrastructure necessary to host servers, network equipment, and to operate the data center. Once the data center is operating, there is the cost of maintaining it, known as cost of ownership. As we mentioned before, the cost of ownership may be represented here by the power consumption, and we use Own(Δt) to denote the cost of ownership for the whole system for a period of time Δt. We also use W(t, i) to denote the power consumption of site Sᵢ consumed at time t, and C_{w}(Δt, i) to be the cost of power consumption for site Sᵢ over time Δt.

$$Cost ( Δ t ) = Inn + Own ( Δ t )$$

$$Own ( Δ t ) = {Own}^{′} ( Δ t ) + {\sum }_{i} {C}_{w} ( Δ t , i )$$

where Own′(Δt) corresponds to all the costs other than power, and the cost of power is given by the amount of power used in watts multiplied by the cost per watt. We compute the cost of power from the power consumption of a site:

$${C}_{w} ( Δ t , i ) = ( {\int }_{{t}_{1}}^{{t}_{2}} W ( t , i ) \cdot d t ) \cdot {u}_{w} , Δ t = {t}_{2} - {t}_{1}$$

To account for different functionality, we further split the power cost into different classes, according to the functionalities of the system:

$$W ( t , i ) = {\sum }_{f} {W}_{f} ( t , i ) ,$$

where f is a functionality of the system, such as crawling and query processing. To estimate the power consumption of each function, we use the following:

$${W}_{f} ( t , i ) = TOPS ( i ) \cdot \frac{{l}_{f} ( i )}{{c}_{f} ( i )} \cdot {e}_{f} ( t , i )$$

where TOPS(i) is the target number of operations per second (e.g., queries processed, Web pages fetched) that site Sᵢ performs at time t; lf(i) is the target latency to perform an operation at site Sᵢ; c_{f} (i) is the capacity in number of simultaneous operations for a server or a cluster, depending on the functionality f; e_{f} (t, i) estimates the power consumption per server or cluster at time t. To estimate such a value, CPU utilization is used, as described in detail in a paper by X. Fan, W.-D. Weber, and L. A. Barroso, entitled “Power provisioning for a warehouse-sized computer,” In Proceedings of the 34th International Symposium on Computer Architecture, pages 13-23, 2007 (which is hereby incorporated by reference in the entirety):

e_{f}(t, i)=mᵢ·(W_{idle}+(W_{busy}−W_{idle})·cpu(OPS(t, i)) (1)

where mᵢ is the size of a group of servers, W_{idle} is the power utilization of a server when the CPU is idle, W_{busy} is the power utilization of a server when the CPU is busy, and cpu(OPS(t, i)) evaluates to the CPU utilization of a server at time t in site Sᵢ. Note that the CPU utilization is a function of the workload at time t given by OPS(t, i).

We use TOPS(i), l_{f}(i), and c_{f}(i) to estimate the number of servers or clusters necessary for a particular function. We use a server when the processing unit is a server. For example, for crawling, we assume that each server crawls individually. For query processing, however, we assume that the processing unit is a cluster because typically systems use document or term partition to increase parallelism when processing a query. Although both document and term partition can potentially cause load imbalance across the servers of a cluster, we do not address such issues here, and simply assume that e_{f}(t, i) evaluates to the total amount of power used at time t. In practice, the values of TOPS(i), l_{f}(i), and c_{f}(i) can be estimated from demand. For example, through experimentation, practitioners can determine that a given cluster of machines is able to process simultaneously c_{f}(i) operations keeping the average latency at l_{f}(i), and estimate that the total traffic of a site will be on average TOPS(i). Also note that e_{f}(t, i) implicitly introduces the current traffic, since the amount of watts depends upon the current traffic.

Specializing equation W_{f}(t, i) to crawling and query processing, we have the following:

$${W}_{c} ( t , i ) = TPPS ( i ) \cdot \frac{{l}_{c} ( i )}{{c}_{c} ( i )} \cdot {e}_{c} ( t , i )$$

$${W}_{q} ( t , i ) = TQPS ( i ) \cdot \frac{{l}_{q} ( i )}{{c}_{q} ( i )} \cdot {e}_{q} ( t , i )$$

The rationale for the above equations is the following. For crawling, a server at site Sᵢ can only have a given number of connections open at a time given by c_{c}(i). Given the number of pages TPPS(i) crawled and the average amount of time to fetch a page l_{c}(i), we determine the total number of servers necessary to crawl. By multiplying by the average amount of power a server uses, we determine the total amount of power necessary for crawling at site Sᵢ. For query processing, we have a similar derivation. To estimate the total amount of power, we multiply the total number of servers in a query processing cluster and the average amount of power a server uses according to Equation 1. To determine the total number of clusters, we estimate the target arrival rate of queries (TQPS(i)) and divide by the number of queries per second a cluster can process (c_{q}(i)/l_{q}(i)). There are different ways to determine the number of servers per cluster. For example, we fix a fraction of the index, and each server holds such a fraction. Note that while equation W_{f}(t, i) may also be specialized to cover indexing operations, although the general equation already includes the cost of indexing functions.

### Adding the Cost of Networking

In a multi-site system, the cost of networking between the sites is determined in step 114. As the rates of network circuits and services vary considerably, the system estimates the cost using the total number of bytes that we need to transfer over a period of time, using a function that converts such a requirement for bandwidth into currency. Typically, the cost of bits per sec (bps) decreases as the total amount of aggregated bandwidth increases. That is, the price of bandwidth often increases sublinearly with the bandwidth contracted. We then assume that the cost of bandwidth C_{bw}(t, i) is a function of the total number of bytes that site Sᵢ transfers at time t. The total cost then becomes:

$$Cost ( Δ t ) = Init + Own ( Δ t ) + {C}_{bw} ( Δ t )$$

$${C}_{bw} ( Δ t ) = {\sum }_{i} {C}_{bw} ( Δ t , i )$$

Latency increases linearly with round-trip time. Longer connections reduce the throughput of crawlers, as their capacity is often given by the total number of simultaneous connections. Having longer connections thus implies fewer requests per second for each server. Front-end servers, which host Web servers that interact with users, also have a similar issue: longer connections imply fewer user requests for each server. Thus, one of the benefits of having sites closer to users is reducing the impact of round trip travel on the cost of search.

In step 118, the system finally presents the results of the above analysis to the user.

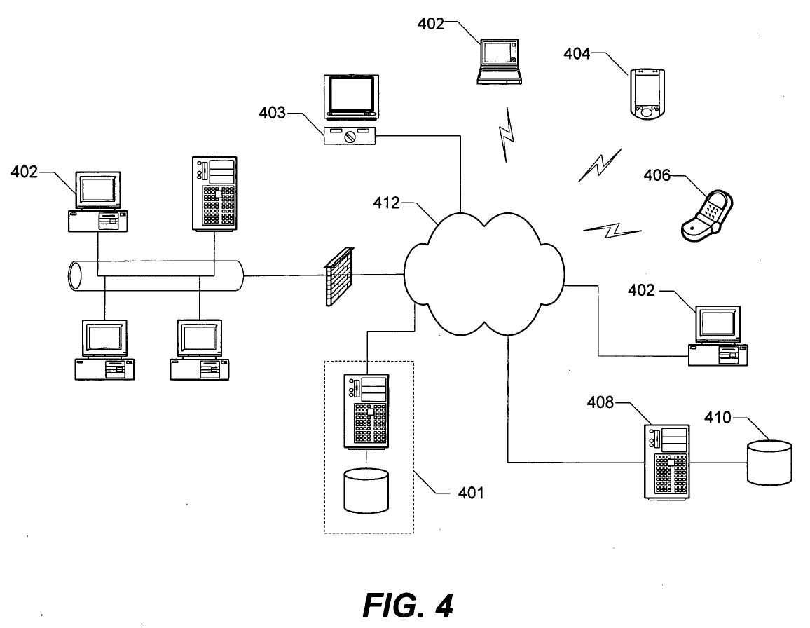

Embodiments assess the feasibility of distributed Web search engines comprising sites that correspond to different geographical locations. A computer system is utilized to develop cost models and evaluate operational costs. Embodiments may include a general purpose computer or a special purpose computer. In one embodiment a special purpose computer system typically used to perform searches may be used to develop the architectural and cost models described herein. This is beneficial in that certain search parameters utilized can also be evaluated by the system, in some cases in an iterative fashion. Such a computer system is illustrated in FIG. 4. This is represented in FIG. 4 by server 408 and data store 410 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 412, and devices 401, 402, 403, 404 and 406.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

### EXAMPLES

To illustrate how embodiments enable the assessment of distributed architectures, we use two simple examples to demonstrate the potential savings with crawling and query processing in a multi-site engine. Note that while the examples demonstrate the potential savings in crawling and query processing, such savings are equally applicable for indexing operations, and that embodiments of the invention also factor in indexing operations.

Crawling

Suppose we have two systems:

System 1: System 1 has one site S11, and its Web collection comprises P pages;

System 2: System 2 has five sites {Sⱼ₂; j ∈ {1, 2, 3, 4, 5}}. The Web collection of site S₁₂ comprises αP pages, 1>α>0.2, and the other sites maintain P·(1−α)/4 pages each. Site S₁₂ has the role of a central site, with more computing power than the others.

We use Wcᵢ(t, j) to denote W_{c}(t, j) for system i, and lcᵢ(j) to denote l_{c}(j) for system i. We then have that the power consumption to crawl all P pages with System 1 at a rate pᵣ=P/Δt, Δt being an interval of choice, is:

W₁(t)=W_{c}_{₁}(t, 1)=pᵣ·X·l_{c}_{₁}(1)

where X represents the computation of all other variables. For simplicity, we assume that the power utilization is the same for all servers across all sites.

With System 2, we have the following:

$${W}_{2} ( t ) = {p}_{r} \cdot X \cdot α \cdot {l}_{{c}_{2}} ( 1 ) + {\sum }_{i = 2 , 3 , 4 , 5} {p}_{r} \cdot X \cdot \frac{1 - α}{4} \cdot {l}_{{c}_{2}} ( i )$$

For the sake of simplicity, we assume that System 2 has been designed in such a way that lc₂ (i) is the same for all i ∈ {2, 3, 4, 5} and equal to l_{α+}l_{α}<l_{c}_{₁}(1). We have that the difference is W₁(t)−W₂(t)=pᵣ·X·(l_{c}_{₁}(1)−α·l_{c}_{₂}(1)−(1−α)·l_{α}),

and l_{c}_{₁}(1)>l_{c}_{₂}(i)+for i ∈ {1, 2, 3, 4, 5} and α>0, we have that W₁(t)−W₂(t)>0.

As the latency of fetching pages is reduced, the power consumption of servers used for crawling is also reduced. Note that this simple computation does not include potential costs that might arise from having to communicate crawlers in different sites. It does show, though, that a crawler distributed across a number of sites, and that requires negligible communication among crawlers in different sites, is cheaper compared to a centralized one.

Query Processing

This example illustrates how embodiments determine the cost changes with the number of sites. This example refers to a fully connected topology where every site is connected to every other site, just one example topology that embodiments of may assess. We assume a fully-distributed system in which there are n sites. Users submit queries to the closest site, and the site either processes them locally, or it sends them all other sites. A user request is therefore classified as either local or global, depending on the sites that process the query. Site Sᵢ is able to resolve a query it receives from a user with probability xᵢ. In this example, we assume that xᵢ is the same across all sites, and we use x to denote the fraction of the total query volume resolved locally.

Following the earlier described cost model, we have that the cost is the sum of power costs and bandwidth costs, ignoring initial costs and remaining costs of ownership. As each site processes a fraction x of the query traffic received locally, and the remainder is processed by all other sites, we have:

$$\begin{matrix}{W}_{q} ( t ) = {\sum }_{i} {W}_{q} ( t , i ) \\ = ( {\sum }_{i} ( {q}_{i} + {\sum }_{j \text{:} j \neq i} {q}_{j} \cdot {T}_{ji} ) ) \cdot \frac{l ( n )}{c} \cdot {e}_{q} \\ = ( QPS \cdot ( x + ( 1 - x ) \cdot n ) \cdot \frac{l ( n )}{c} \cdot {e}_{q} )\end{matrix}$$

where:

$${q}_{i} + {\sum }_{j \text{:} j \neq i} {q}_{j} \cdot {T}_{ij} = TQPS ( i ) ,$$

for all i;
q, is the number of queries per second that users submit directly to site Sᵢ, and

$$QPS = {\sum }_{i} {q}_{i} ;$$

T_{i,j} is the fraction of queries that the site Sᵢ sends to site Sⱼ for processing:
l(n) is the latency to process a query. We assume that it decreases with the number of sites such that l(n)=k/n, where k is a constant representing the time to process a query in a single-site system (DQ principle
c is the capacity of a query cluster. We assume that it is constant across sites and independant of the number of sites;
e_{q} is the number of watts that query processors consume. For simplicity, we assume that e_{q}(t, i)=e_{q} for all t and i;
U_{w} is the cost of energy given in dollars per watt-hour (Wh), ]

Note that W_{q}(t) is a value independent of t in this case, and therefore W_{q} is used instead. The cost of power considering only the cost of query processing is:

$$\begin{matrix}{C}_{w} ( Δ t ) = ( {\int }_{{t}_{1}}^{{t}_{2}} {W}_{q} \cdot d t ) \cdot {U}_{w ,} Δ t = {t}_{2} - {t}_{1} \\ = {W}_{q} \cdot Δ t \cdot {U}_{w}\end{matrix}$$

and to make the units compatible, we have to convert W_{q}·Δt from joules to watt-hour by dividing it by 3600, and we finally have:

$$\begin{matrix}{C}_{w} ( Δ t ) = \frac{{W}_{q} \cdot Δ t}{3600} \cdot {U}_{w} \\ = {W}_{q} \cdot 720 \cdot {U}_{w}\end{matrix}$$

given in dollars and assuming that Δt=30·24·3600 (one month in seconds). The amount of traffic increases linearly with the number of global queries, and with the number of sites. The cost of network bandwidth is thus represented as follows:

$${C}_{bw} ( Δ t ) = {\sum }_{i} {C}_{bw} ( Δ t , i ) = ( {\sum }_{i , j \text{:} j \neq i} {q}_{j} \cdot {T}_{ji} \cdot b ) \cdot Δ t \cdot {U}_{bw}$$

where b is the average number of bits for each request; U_{bw} is the cost of bandwidth in dollars per Mbps per month; and Δt is time in number of months. For this particular example, we have that

$${T}_{ji} = ( 1 - x ) , {q}_{j} = \frac{QPS}{n} ,$$

and Δt=1 month:

$$\begin{matrix}{C}_{bw} ( Δ t ) = ( {\sum }_{i , j \text{:} j \neq i} \frac{QPS}{n} \cdot ( 1 - x ) \cdot b ) \cdot {U}_{bw} \\ = ( QPS \cdot ( 1 - x ) \cdot ( n - 1 ) \cdot b ) \cdot {U}_{bw}\end{matrix}$$

Adding the terms, we have that the total cost is given by the following:

$$\begin{matrix}Cost ( 1 month ) = {C}_{w} ( 1 month ) + {C}_{bw} ( 1 month ) \\ = QPS \cdot ( {U}_{w} \cdot 720 \cdot ( x + ( 1 - x ) \cdot n ) \cdot \frac{l ( n )}{c} \cdot \\ {e}_{q} + {U}_{bw} \cdot ( 1 - x ) \cdot ( n - 1 ) \cdot b )\end{matrix}$$

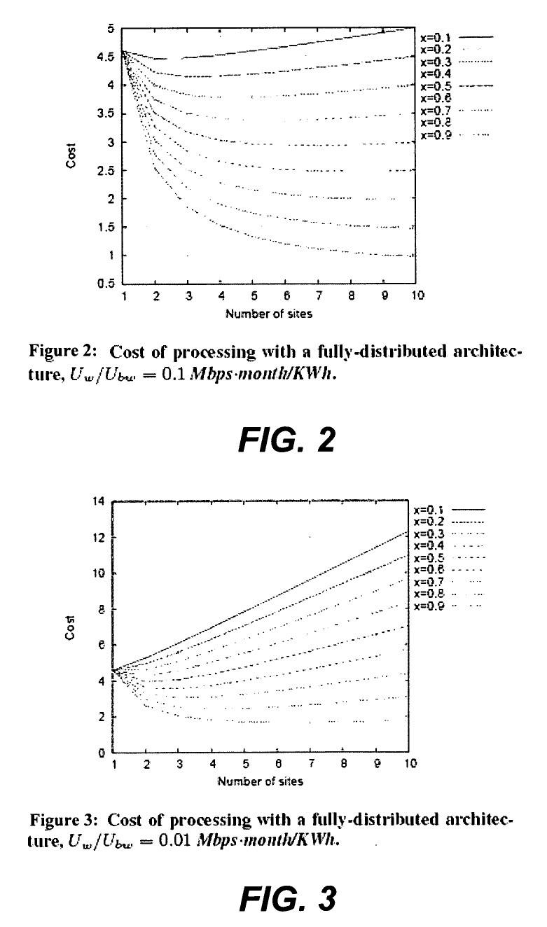

FIGS. 2 and 3 illustrate Cost(t), assuming that QPS=1 (cost of one query per second). They show how the cost varies for different fractions of locality x, assuming that U_{w}/U_{bw} is 0.1 Mbps·month/KWh, and 0.01 Mbps·month/KWh, respectively. A centralized architecture corresponds to the point with value n=1. From the figures, if the cost of bandwidth is low enough, then making the engine distributed has a lower overall cost. As we increase the cost of bandwidth, we observe that the cost of a distributed architecture becomes higher, and at some point for no value of the locality parameter a distributed engine has lower costs. In fact, the optimal number of nodes is

$${C}_{n} \cdot ( \sqrt{\frac{{U}_{w}}{{U}_{bw}} \frac{1}{1 - x}} ) ,$$

where Cₙ is a normalization constant that cancels out the unit of

$$\frac{{U}_{w}}{{U}_{bw}}$$

and can be computed from the formula above. Hence, the optimal number grows when locality increases and when the fraction U_{w}/U_{bw} increases. That is, for small relative values of the bandwidth cost, such as U_{w}/U_{bw}=0.1 Mbps·month/KWh, it is observed that for all values of the locality parameter there is a number of sites for which the cost is lower. For larger differences in the cost per unit of power and bandwidth, such as U_{w}/U_{bw}=0.01 Mbps·month/KWh, we have that for some values of the locality parameter the cost of a distributed architecture is never lower compared to a centralized architecture. This is because the cost of networking dominates the total cost of the system for such values.

While the invention has been particularly shown and described with reference to specific embodiments thereof, it will be understood by those skilled in the art that changes in the form and details of the disclosed embodiments may be made without departing from the spirit or scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer program product, comprising a computer usable medium having a computer readable program code embodied therein, said computer readable program code adapted to be executed to implement a method for designing a search engine system, said method comprising:
establishing a target latency for queries of a search processing system that services queries from a first geographic area and a second geographic area distant from the first geographic area;
receiving a proposed topology for the search processing system;
receiving a proposed location for a first site to service queries of the first and second geographic areas;
receiving a proposed location for a second site to service queries of the first and second geographic areas, the first site being geographically distant from the second site;
determining a power cost for power consumption of the first site by estimating power consumption of crawling operations of the first site;
determining a power cost for power consumption of the first site by estimating power consumption of query processing operations of the first site;
determining a power cost for power consumption of the second site by estimating power consumption of crawling operations of the second site;
determining a power cost for power consumption of the second site by estimating power consumption of query processing operations of the second site; and
calculating an overall operating cost of the search processing system from the power costs given the target latency, geographic areas to be served, proposed topology and locations.

2. The computer program product of claim 1, wherein determining the power cost for operations of the first and second site comprises:
computing the target number of operations per second that each site performs;
determining a ratio of the target latency to the number of simultaneous operations for a server or cluster; and
determining the power consumption per server or cluster.

3. A computer system configured to:
receive a target query volume;
calculate the cost of operation for a proposed distributed search system comprising at least one search repository site geographically distant from a second search repository site;
calculate the cost of networking the search repository sites of the distributed search system;
calculate the cost of operation for a proposed centralized search system; and
determine whether the cost of operation of the proposed distributed system is greater or less than the cost of operation of the proposed centralized system.

4. The system of claim 3, wherein in order to calculate the cost of operation the system is configured to:
determine the functionality of each site of the distributed system; and
compute the cost of power for each site based upon the functionality of the site and the power consumption of the site.

5. The system of claim 4, wherein in order to compute the cost of power for each site the system is configured to:
(a) Compute the target number of operations per second that each site performs;
(b) Determine a ratio of the target latency to the number of simultaneous operations for a server or cluster;
(c) determine the power consumption per server or cluster; and
(d) multiply (a) (b) and (c).

6. The system of claim 3, wherein in order to calculate the cost of operation the system is configured to factor in the latency requirements of the distributed search system and the centralized search system.

7. The system of claim 6, wherein in order to factor in the latency requirements and calculate the cost of operation the system is configured to determine a redundancy of servers necessary for the distributed search system.

8. The system of claim 7, wherein in order to factor in the latency requirements and calculate the cost of operation the system is configured to determine a redundancy of servers necessary for the centralized search system.

9. The system of claim 6, wherein in order to factor in the latency requirements and calculate the cost of operation the system is configured to determine a redundancy of bandwidth necessary for the distributed search system.

10. The system of claim 9, wherein in order to factor in the latency requirements and calculate the cost of operation the system is configured to determine a redundancy of bandwidth necessary for the centralized search system.

11. The system of claim 3, wherein in order to determine the power consumption of the server or cluster the system is further configured to determine CPU utilization for a CPU of the server or cluster.

12. A computer system configured to:
calculate a cost of operation for a first proposed distributed search system comprising at least one search repository site geographically distant from a second search repository site of the first proposed system;
calculate the cost of networking the search repository sites of the first distributed search system;
calculate a cost of operation for a second proposed distributed search system comprising at least one search repository site geographically distant from a second search repository site of the second proposed system;
calculate the cost of networking the search repository sites of the second distributed search system; and
determine whether the cost of operation of the first proposed distributed system is greater or less than the cost of operation of the second proposed distributed system.

13. The system of claim 12, wherein in order to calculate the cost of operation the system is configured to:
determine the functionality of each site of each distributed system;
compute the cost of power for each site based upon the functionality of the site and the power consumption of the site.

14. The system of claim 13, wherein the functionality comprises, search operations, query operations, and indexing operations, and wherein the system is configured to compute the cost of power for each site based upon the search operations, query operations, and indexing operations of the site.

15. The system of claim 13, wherein in order to compute the cost of power for each site the system is configured to:
(a) compute the target number of operations per second that each site performs;
(b) determine a ratio of the target latency to the number of simultaneous operations for a server or cluster;
(c) determine the power consumption per server or cluster; and
(d) multiply (a) (b) and (c).

16. A computer program product, comprising a computer usable medium having a computer readable program code embodied therein, said computer readable program code adapted to be executed to implement a method for designing a search engine system, said method comprising:
receiving an estimate for an overall query load for the search engine system or a portion thereof; and
determining the cost of servicing the estimated query load by:
(1) estimating a fraction of the overall query load that will be serviced by each of a plurality of geographically separated and distinct facilities; and
(2) estimating the power consumption for the plurality of geographic locations.

17. A computer program product, comprising a computer usable medium having a computer readable program code embodied therein, said computer readable program code adapted to be executed to implement a method for designing a search engine system, said method comprising:
determining a sum of power costs for at least two designs, each design having a different number of nodes from the other designs;
determining a sum of bandwidth costs for the at least two designs, each design having a different number of nodes from the other designs; and
determining an optimal number of nodes for the search engine system.

18. The computer program product of claim 17, wherein determining the optimal number of nodes is calculated as
$${C}_{n} \cdot ( \sqrt{\frac{{U}_{w}}{{U}_{bw}} \frac{1}{1 - x}} ) ,$$
where U_{w} is the cost of power per month, and U_{bw} is the cost of bandwidth per month, and Cₙ is a normalization constant and that cancels out the unit of U_{w}/U_{bw}.
